(19) United States
(12) Patent Application Publication
(10) Pub. No.: US 2002/0094930 A1
(43) Pub. Date: Jul. 18, 2002

(54) Alkali resistant silica refractory brick, method for producing the same and glass manufacturing furnace containing the same

(76) Inventors: John T. Brown, (US); John F. Wosinski, Corning, NY (US); Jean A. Wosinski, Corning, NY (US)

Correspondence Address: CORNING INCORPORATED, SP-TI-3-1, CORNING, NY, 14831

(21) Appl. No.: 09/930,087

(22) Filed: Aug. 15, 2001

Related U.S. Application Data
(63) Continuation-in-part of application No. 09/414,624, filed on Oct. 8, 1999, now Pat. No. 6,313,057.
(60) Provisional application No. 60/103,673, filed on Oct. 9, 1998.

(51) Int. Cl. C04B 35/03

(52) U.S. Cl. 501/123

(57) ABSTRACT

Disclosed are a new silica refractory brick, a method for making the same and a glass manufacturing furnace comprising the same. Said brick is made from quartz grains, contains calcium oxide binder, consists essentially of (i) silica and (ii) less than 1 weight percent of calcium oxide binder, and when subject to ASTM C-987 alkali vapor test at 1370° C. for 24 hours, has an erosion depth of less than 4 mm and a penetrated depth of less than 3 mm. The brick has reduced level of calcium oxide binder and improved resistance to alkalis and is particularly useful in oxygen-fuel fired glass furnaces.

### CROSS REFERENCED APPLICATIONS

This application is a continuation-in-part application of U.S. patent application, Ser. No. 09/414,624, which, in turn, claimed the benefit of U.S. provisional application, serial No. 60/103,673, filed Oct. 9, 1998, entitled “Alkali Resistant Silica Refractory”, by John T. Brown and John F. Wosinski, deceased.

### FIELD OF THE INVENTION

The preset invention relates to a silica refractory brick, a method for producing the same and glass manufacturing furnaces comprising the same. In particular, the present invention relates to a silica refractory brick that is resistant to degradation in alkali containing environment, such as oxygen-fuel fired furnaces, method for producing the brick, and glass manufacturing furnaces, in particular, oxygen-fuel fired furnaces, comprising the brick.

### BACKGROUND OF THE INVENTION

Silica bricks are used as a refractory in building and repairing industrial furnaces, such as coke ovens, hot blast stoves and glass furnaces. Silica brick crowns have been successfully used in glass furnaces for producing container, float glass, table-ware and TV panel glass. They have the attributes of a relatively long life, excellent insulation at a low cost, and limited defects as silica is the dominant oxide. U.S. Pat. Nos. 4,866,015, 5,310,078 and 5,496,780, which are incorporated by reference herein in their entirety, disclosed the use and properties of silica refractory bricks.

There has been very little recent improvement in the manufacture of the conventional silica refractory for use in glass furnaces. Conventional silica bricks are typically manufactured by mixing quarts grains with calcium oxide binder, pressing the mixture into bricks and firing the bricks to temperatures up to 1700° C. to allow more than about 95% of the quartz to transform to cristobalite and tridymite. This transformation avoids the problems associated with expansion changes of α and β quartz and allows for faster heating of the furnaces in which the brick is used. Conventional silica refractory bricks used in glass furnaces contain about 2.5% to 3% by weight of calcium oxide which acts as a binder between the silica grains.

Environmental concerns, particularly the desire to lower the emission of nitrogen oxides from industrial furnaces, have driven the replacement of air-fuel firing of glass furnaces to oxygen-fuel firing. Starting in the early 1980s, more and more glass furnaces have been switched to oxygen-fuel firing. The change from air-fuel firing of glass furnaces to oxygen-fuel firing has increased alkalis in the furnace environment, for example, sodium hydroxide in glass melting furnaces. Consequently, the increased alkalis in the furnace environment have caused additional and/or accelerated corrosion of the silica refractories. In some instances, the switch from air-fuel firing to oxygen-fuel firing increases the alkalis, such as sodium hydroxide, by a factor of four in the glass furnaces.

Thus, alkalis in the furnace have been identified as being detrimental to silica refractory bricks. The crowns of glass furnaces are typically made of silica refractory bricks. The surface of an oxygen-fuel fired glass furnace crown made from conventional silica refractory bricks can be degraded by about one to two inches per year. The typical life of a crown of a float glass furnace using oxygen-fuel firing is about seven years, which is a reduction of about five years compared with a furnace using air-fuel firing.

Alternatives to conventional silica refractories include alumina-zirconia-silica (AZS) refractories and amorphous silica refractories that do not contain any binder. These bricks may have good resistant properties against alkali containing environment. However, one disadvantage with these alternative refractories is that they are much more expensive than the conventional silica refractory bricks made from quartz grains and contain calcium oxide binder. In some glass furnaces, cost of these bricks is prohibiting. Although amorphous silica shows minimal thermal expansion to about 1200° C., it begins to devitrify above this temperature. The devitrification will be accompanied by a volume reduction as the crystalline phases have higher specific gravity than the vitreous silica phase. This shrinkage of the refractory in service would cause considerable concern since it might result in an opening up of joints between bricks, thus causing more penetration and “rat-holing” due to alkali attack.

There is a distinct need for a silica refractory that is resistant to alkali attack and degradation in oxygen-fuel fired furnaces, but is less expensive than AZS and amorphous silica refractory materials. It would be advantageous to provide a refractory brick that could be utilized for long life spans of glass furnace crowns and would require very little maintenance.

The inventors of the present invention have discovered that calcium oxide binder contributes significantly to the wear and deterioration of conventional silica refractory bricks in alkali containing atmosphere. The inventors of the present invention also have discovered that reducing the amount of calcium oxide binder used in the conventional silica refractory bricks can advantageously improve the brick's resistance to alkalis. It is based on these discoveries that the present inventors have invented the new silica refractory brick of the present invention.

Japanese patent 50-159503 disclosed a method for making a silica refractory brick. Said method is characterized in that 0.5 to 1.5 weight percent CaO is mixed with a silica brick raw material, and 1 to 5 weight percent silica ultra micro powder that contains 90 or more weight percent of SiO₂ is added to the raw material together with a dispersing agent. However, this patent is primarily concerned with the density and porosity of the brick. Filed in 1975 and published in 1976, which was well before the development of oxygen-fuel fired furnaces, this patent document did not disclose any information on the brick's resistance to alkali containing environment. Moreover, no suggestions or teachings on the effect of reducing calcium oxide binder quantity on the alkali resistance property of the brick were made in this patent document.

### SUMMARY OF THE INVENTION

Accordingly, the present invention generally provides a new silica refractory brick with improved resistance to alkali containing environment compared to conventional silica refractory bricks, but less expensive than AZS and amorphous silica refractory bricks. Said brick

is made from quartz grains,

contains calcium oxide as a binder,

consists essentially of (i) silica and (ii) less than 1 weight percent added calcium oxide binder, and

when subject to the ASTM C-987 alkali vapor test at 1370° C. for 24 hours, has an erosion depth of less than 4 mm and a penetrated depth of less than 3 mm.

Preferably, the calcium oxide binder is present in the brick in an amount between about 0.1 and 0.8 weight percent, and most preferably, the silica refractory contains between about 0.3 and 0.7 weight percent calcium oxide binder. Preferably, the refractory brick, when subject to the ASTM C-987 alkali vapor test at 1370° C. for 24 hours, has an erosion depth of less than 2 mm and a penetrated depth of less than 2 mm.

The refractory brick of the present invention is useful in glass manufacturing furnaces, particularly in the crowns of the furnaces. Because of its improved resistance to alkali containing environment compared to conventional silica refractory bricks, coupled with its low cost compared to AZS and amorphous silica bricks, it can be advantageously used in glass manufacturing furnaces with elevated alkali quantities, such as oxygen-fuel fired glass furnaces.

The present invention further provides a method for producing the new silica refractory brick of the present invention, comprising adding less than one weight percent calcium oxide binder to the starting material composition of the brick prior to firing the brick. In a preferred embodiment of the present invention, the method involved adding between 0.1 and 0.8 weight percent calcium oxide binder, and in a more preferred embodiment, the invention involves adding between 0.3 and 0.7 weight percent calcium oxide binder to the starting material composition.

In still another aspect, the present invention provides a new glass manufacturing furnace comprising the new silica refractory bricks of the present invention. The glass manufacturing furnace may incorporate in its crown the new silica refractory bricks of the present invention. Owing to the improved alkali resistance of the new silica bricks of the present invention, the glass manufacturing furnace can advantageously be used in processes where high alkali quantities are involved, for example, a glass manufacturing process using oxygen-fuel firing.

Additional features and advantages of the invention will be set forth in the following description. It is to be understood that both the foregoing general description and the following detailed description are exemplary and explanatory only and are intended to provide further explanation of the invention as claimed.

### DESCRIPTION OF THE DRAWING

FIG. 1 is a photograph of brick samples cut through the center after ASTM C-987 alkali vapor test. On the left is a brick sample of conventional silica refractory brick containing 3.0 weight percent of calcium oxide binder, on the right a low lime silica brick sample of the present invention containing 0.8 weight percent calcium oxide binder.

### DETAILED DESCRIPTION OF THE INVENTION

As mentioned above, conventional fused silica refractories made from quartz grains typically contain approximately 2.5 to 3 weight percent calcium oxide binder. Conventional silica refractory bricks are typically manufactured by first mixing together the calcium oxide binder with crystalline quarts grains having the right characteristics for conversion to the high temperature crystal phases of silica. Then, the brick is formed, typically by pressing (e.g., dry pressing). Subsequently the brick is fired at temperatures high enough to convert the quartz into cristobalite and tridymite, which are stable at high temperatures.

Without being bound by any particular theory, the present inventors believe that when conventional silica bricks containing the usual levels of 2.5 to 3 weight percent calcium oxide are used in furnaces, the high furnace temperatures causes the calcium to react with silica to form pseudo wollastonite or sodium metasilicate. This mineral surrounds the silica grains, and forms a continuous path which apparently acts as pathway for drawing alkali from the furnace deep into the bricks. Penetration of the alkali below the face of the brick causes premature corrosion and deterioration of the brick, leading to early failure of the furnace.

Thus, the present inventors have discovered that calcium oxide binder significantly contributes to the deterioration and wear of conventional silica refractories in furnace environments containing alkali vapors. It is based on this discovery that the inventors contemplated and invented the new silica bricks of the present invention, which has a reduced level of calcium oxide binder. Experiments on the brick of the present invention indicate that it has improved resistance to alkali containing environment compared with conventional silica refractories. In summary, the new silica refractory brick of the present invention

is made from quartz grains,

contains calcium oxide as a binder,

consists essentially of (i) silica and (ii) less than 1 weight percent added calcium oxide binder, and

when subject to the ASTM C-987 alkali vapor test at 1370° C. for 24 hours, has an erosion depth of less than 4 mm and a penetrated depth of less than 3 mm.

Like conventional silica refractory bricks, the new silica refractory brick of the present invention is made from quartz grains and contains calcium oxide binder. However, it is distinct from the conventional silica refractories in that it has a reduced calcium oxide binder level and a higher resistance to alkalis. Conventional silica refractories have a calcium oxide binder level between 2.5 to 3 weight percent. When subject to ASTM C-987 vapor test under 1370° C. for 24 hours, conventional silica refractories typically have an erosion depth of over 6 mm and a penetrated depth of over 3 mm, whereas the brick of the present invention has an erosion depth of less than 4 mm and a penetrated depth of less than 3 mm. In a more preferred embodiment, the brick of the present invention has an erosion depth of less than 2 mm and a penetrated depth of less than 2 mm when subject to ASTM C-987 alkali vapor test under 1370° C. for 24 hours. This demonstrates that the silica refractory brick of the present invention has an improved resistance against alkali atmosphere. Experimentation conducted on conventional silica refractory bricks and the new brick of the present invention in practical glass furnace have resulted in the same conclusion. It is known to one of ordinary skill in the art that erosion and penetration of alkalis into the silica brick can cause deterioration, corrosion, and wear of the brick. The higher the rate of alkali erosion and penetration, the faster the brick wears. Therefore, the new silica brick with improved alkali resistance would have a prolonged life span compared to conventional silica refractory bricks in alkali containing environment, for example, in a oxygen-fuel firing glass manufacturing furnace.

The present invention also provides a method for producing the new silica refractory brick, comprising adding less than 1 weight percent of calcium oxide binder, calculated on the basis of calcium oxide, to the brick composition prior to firing the brick. Preferably, calcium oxide binder is added in the amount between 0.1 and 0.8 weight percent. More preferably, calcium oxide binder is added in the amount between 0.3 and 0.7 weight percent. In one embodiment, calcium oxide is added in the amount between 0.1 and 0.5 weight percent. In this regard, procedures in conventional processes can be used. For example, raw materials containing silica can be mixed with lime to form a starting brick composition, which is subsequently formed by pressing, then optionally dried, and then subject to firing or multiple firing to produce the final bricks. One of skill in the art can select the suitable components of the starting materials, their amount used, the forming conditions and equipment, firing temperature and firing time profiles to produce the brick of desired properties in light of the teachings herein. Manufacturing procedures for silica refractories made from quartz are discussed in U.S. Pat. No. 5,310,708, which is incorporated herein in its entirety by reference.

With regard to the silica containing materials, siliceous stones and/or its pulverized form can be used. Depending upon the quality of the quartz grains mined and the requirements for the final bricks in terms of including, but not limited to, porosity, density, thermal conductivity and the like, quartz grains as mined may be used as they are without further treatment, or can be subject to further treatment including, but not limited to, purification, pulverization, particle size distribution control and the like before mixing with other starting materials. It is well known that particle size distribution of the quartz grains may influence the properties of the final bricks, for example, their mechanical strength. Various sizes of quartz grains may be added to adjust the particle size distribution, as in the manufacture of conventional silica bricks.

With regard to the calcium oxide binder used in the method of present invention, it can be in the form of calcium oxide per se, or any other suitable source material that can generate calcium oxide to bind the quartz grain in the forming and firing procedures, or a combination thereof. Examples of such calcium oxide source materials include, but not limited to, calcium oxide hydrate, calcium carbonate, dolomitic limestone, and the like, or a combination thereof. One of skill in the art can determine the amount of source materials that should be used in the starting composition according to the required calcium oxide binder level in the final brick.

The amount of calcium oxide binder in the final brick can be up to 1.0 weight percent. If the calcium oxide binder level is higher than 1.0 weight percent, its resistance to alkali containing environment will be compromised. However, to achieve good mechanical strength of the final brick, especially an acceptable modulus of rupture, calcium oxide binder is required. The amount of calcium oxide binder is preferably between 0.1 and 0.8 weight percent of the total brick composition, more preferably between 0.3 and 0.7 weight percent. In a specific embodiment, the amount of calcium oxide binder is used in the amount between 0.1 and 0.5 weight percent of the brick composition.

In another aspect, the present invention provides a glass manufacturing furnace comprising the new silica refractory bricks of the present invention. The bricks used in the glass manufacturing furnace contains calcium oxide binder in the amount less than 1.0 weight percent. Preferably, the bricks used in the furnace comprise between about 0.1 and 0.8 weight percent of calcium oxide binder. More preferably, the bricks used in the furnace comprise between about 0.3 and 0.7 weight percent of calcium oxide binder. In a specific embodiment, the bricks used in the furnace comprise between about 0.1 and 0.5 weight percent of calcium oxide binder. Given the refractory properties of the present invention brick, it can be incorporated into the glass manufacturing furnace in the crown, breast and other portions. The furnace can be a conventional air-fuel fired furnace or an oxygen-fuel fired furnace. The furnace can be used for producing float glass, glass containers or other glass articles. The shape, structure, volume, capacity and other design features can be selected by one of skill in the art according to its use. Because of the improved resistance to alkalis of the present invention bricks, use of them in either air-fuel or oxygen-fuel fired glass manufacturing furnace will increase the furnace's life span. However, because oxygen-fuel furnaces have a much higher alkali level than air-fuel fired furnaces, which is particularly detrimental to conventional silica refractory bricks, use of the present invention bricks in them would be particularly advantageous. Therefore, the preferred glass manufacturing furnace of the present invention is an oxygen-fuel fired glass manufacturing furnace. However, other use of the present invention silica refractory brick can be easily contemplated by one of ordinary skill in the art where refractoriness and/or resistance to alkalis are required.

The present invention is further illustrated by the following non-limiting examples.

### EXAMPLES

### Example 1

Three samples of silica bricks were produced from quartz grains according to customary brick manufacturing procedures. The samples were cylinders measuring 4.5 inches long and 1.5 inches in diameter. These cylinders were inserted into an oxygen-fuel fired glass furnace wall to determine the level of alkali penetration beneath the hot face of the sample, i.e., the end of the sample facing the interior of the furnace which is exposed to alkali vapors.

The samples were all made from quartz grain and contained varying amounts of calcium oxide binder. Sample “A” representing a conventional silica refractory, contained approximately 2.7 weight percent added calcium oxide binder. Sample “B” contained approximately 0.7 weight percent added calcium oxide binder. Sample “C” contained approximately 0.1 weight percent calcium oxide binder.

The three samples were placed in a glass furnace for 85 hours and exposed to temperatures of approximately 2800° F. The three samples were then rated from best to worst, based on the extent of penetration of the glass beyond the hot face of each sample. Penetration of the glass was observed by using optical microscopic examination, scanning electron microscopic examination and scanning electron microscope energy dispersive analysis.

Sample “A”, containing 2.7 weight percent calcium oxide binder, exhibited the deepest and worst penetration of glass beneath the hot surface of the sample. Sample “B” and sample “C”, respectively exhibited less deep and severe penetration of the glass beneath the hot face of the sample. Thus, the samples containing a lower weight percent of calcium oxide binder exhibited better performance in that the glass did not penetrate the surface of the sample as deeply as the conventional silica refractory material containing 2.7 weight percent calcium oxide binder.

It is presently preferred, however, that greater than 0.1 weight percent of calcium oxide binder be added to the mixture of quartz prior to firing, as it was discovered that the sample containing 0.1 weight percent lime did not hold together as well as the sample containing 0.7 weight percent calcium oxide binder. The appropriate amount of calcium oxide binder and the grain size of the quartz can be optimized through experimentation to provide a silica brick having the appropriate strength and resistance to alkali attack for a particular application.

### Example 2

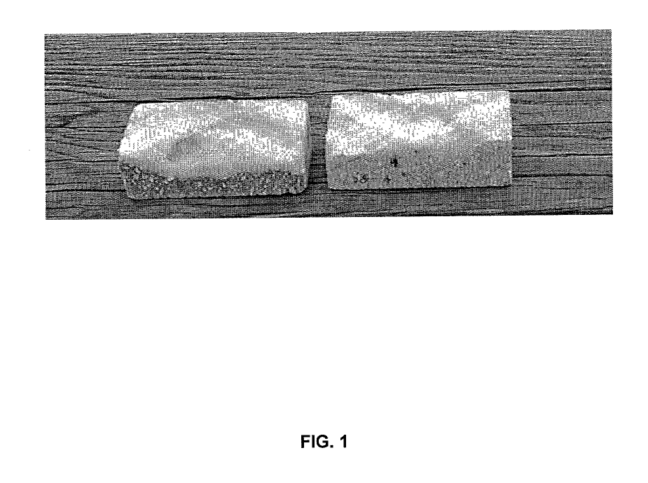

In this example, conventional silica refractory brick containing 3.0 weight percent of calcium oxide binder and the present invention silica refractory brick containing 0.8 weight percent of calcium oxide binder were prepared according to customary method. Cut slabs of the two bricks were subjected to ASTM C-987 alkali vapor test to determine their resistance to alkalis. The two test samples were used as lids over a crucible containing sodium carbonate. The test samples were heated to 1370° C. (2500° F.) and held for 24 hours. After cooling, the samples were cut to observe sodium carbonate penetration and erosion of the sample. It was observed that the amount of erosion by the alkali vapor was considerably less for the low-lime silica refractory of the present invention compared to the conventional silica product. Afterwards, scanning electronic microscope (SEM) was used to determine the degree of penetration of the three samples by sodium. It was observed that the degree of alkali penetration of the two crystalline silica samples was essentially in proportion to the calcium oxide in the matrix. Referring to the drawing, FIG. 1 compares the two samples cut through the center. On the left in the figure is the conventional silica brick sample, on the right the low-lime silica brick sample of the present invention. The brick surface and the area below the exposed surface can be observed. The conventional silica sample was eroded to a depth of about 6.5 to 7 mm and showed a penetrated zone to a depth of 3 to 5 mm. The low-lime silica refractory brick of the present invention showed an erosion of about 2 mm and a penetrated zone of 1.5 to 2 mm.

It is to be understood that the above non-limiting examples are for illustration and explanation purposes only. It is also to be understood that in view of the above description, many modifications and variations can be made by one of ordinary skill in the art without departing from the scope and spirit of the present invention. Thus, it is intended that the present invention covers the modifications and variations of this invention provided they come within the scope of the appended claims and their equivalents.

1. A silica refractory brick made from quartz grains and containing calcium oxide binder consisting essentially of (i) silica and (ii) less than 1 weight percent added calcium oxide binder, wherein said brick, when subject to the ASTM C-987 alkali vapor test at 1370° C. for 24 hours, has an erosion depth of less than 4 mm and a penetrated depth of less than 3 mm.

2. A refractory brick in accordance with claim 1, wherein the brick contains between 0.1 and 0.8 weight percent added calcium oxide binder.

3. A refractory brick in accordance with claim 1, wherein the brick contains between 0.3 and 0.7 weight percent added calcium oxide binder.

4. A refractory brick in accordance with claim 1, wherein the brick contains between 0.1 and 0.5 weight percent added calcium oxide binder.

5. A refractory brick in accordance with claim 1, wherein the brick, when subject to the ASTM C-987 alkali vapor test at 1370° C. for 24 hours, has an erosion depth of less than 2 mm and a penetrated depth of less than 2 mm.

6. A refractory brick in accordance with claim 5, wherein the brick contains between 0.1 and 0.8 weight percent added calcium oxide binder.

7. A refractory brick in accordance with claim 5, wherein the brick contains between 0.3 and 0.7 weight percent added calcium oxide binder.

8. A refractory brick in accordance with claim 5, wherein the brick contains between 0.1 and 0.5 weight percent added calcium oxide binder.

9. A method for producing a brick made from quartz grains and containing calcium oxide binder consisting essentially of (i) silica and (ii) less than 1 weight percent added calcium oxide binder, wherein said brick, when subject to the ASTM C-987 alkali vapor test at 1370° C. for 24 hours, has an erosion depth of less than 4 mm and a penetrated depth of less than 3 mm, said method comprising adding less than 1 weight percent of calcium oxide binder to the composition prior to the firing of the brick.

10. A method in accordance with claim 9, wherein the method comprises adding between 0.1 and 0.8 weight percent calcium oxide binder.

11. A method for producing the bricks of claim 9, wherein the method comprises adding between 0.3 and 0.7 weight percent of calcium oxide binder.

12. A glass manufacturing furnace comprising a silica refractory brick made from quartz grains and containing calcium oxide binder consisting essentially of (i) silica and (ii) less than 1 weight percent added calcium oxide binder, wherein said brick, when subject to the ASTM C-987 alkali vapor test at 1370° C. for 24 hours, has an erosion depth of less than 4 mm and a penetrated depth of less than 3 mm.

13. A glass manufacturing furnace in accordance with claim 12, which is oxygen-fuel fired.

14. A glass manufacturing furnace in accordance with claim 12, wherein the brick contains between 0.1 and 0.8 weight percent added calcium oxide binder.

15. A glass manufacturing furnace in accordance with claim 12, wherein the brick contains between 0.3 and 0.7 weight percent added calcium oxide binder.

16. A glass manufacturing furnace in accordance with claim 12, wherein the brick contains between 0.1 and 0.5 weight percent added calcium oxide binder.

17. A glass manufacturing furnace in accordance with claim 12, wherein the brick, when subject to the ASTM C-987 alkali vapor test at 1370° C. for 24 hours, has an erosion depth of less than 2 mm and a penetrated depth of less than 2 mm.

18. A glass manufacturing furnace in accordance with claim 17, wherein the brick contains between 0.1 and 0.8 weight percent added calcium oxide binder.

19. A glass manufacturing furnace in accordance with claim 17, wherein the brick contains between 0.3 and 0.7 weight percent added calcium oxide binder.

20. A glass manufacturing furnace in accordance with claim 17, wherein the brick contains between 0.1 and 0.5 weight percent added calcium oxide binder.
